(19) United States
(12) Patent Application Publication
(10) Pub. No.: US 2026/0013520 A1
(43) Pub. Date: Jan. 15, 2026

(54) SYSTEM FOR APPLYING A GASEOUS BIOCIDE TO A FOODSTUFF AND METHOD

(71) Applicant: Cellysis PTY Ltd, Hoddles Creek, Victoria (AU)

(72) Inventor: Andrew INGLIS, Hoddles Creek, Victoria (AU)

(73) Assignee: Cellysis PTY Ltd, Hoddles Creek, Victoria (AU)

(21) Appl. No.: 19/128,223

(22) PCT Filed: Nov. 8, 2023
(86) PCT No.: PCT/AU2023/051126

§ 371 Date: May 8, 2025

(30) Foreign Application Priority Data
Nov. 10, 2022 (AU) 2022903372

(51) Int. Cl. A23B 2/708; A23B 2/704; A23B 2/788; A23B 7/10

(52) U.S. Cl. CPC A23B 2/708; A23B 2/7045; A23B 2/788; A23B 7/10

(57) ABSTRACT

A system for applying a gaseous biocide to a foodstuff, comprising: a treatment chamber having a vapor partitioning passage in which biocide is applied to the foodstuff; a conveyor extending from a first location outside the treatment chamber for conveying the foodstuff, through a first aperture in a wall of the treatment chamber, through the vapor partitioning passage, through a second aperture in a wall of the treatment chamber, and terminating at a second location outside the treatment chamber; an air distribution system supplying air into the treatment chamber, and an air extraction system through which air and remaining biocide is drawn from the treatment chamber. Pressure within the treatment chamber is maintained lower than outside the treatment chamber and lower than within the vapor partitioning passage, whereby air drawn into the treatment chamber is directed away from the vapor partitioning passage and gaseous biocide is prevented from exiting.

### FIELD OF THE INVENTION

The present invention relates to a system for applying a gaseous biocide to a foodstuff and associated methods.

### BACKGROUND

It is desirable to increase the shelf life of a foodstuff susceptible to microbial spoilage, without having detrimental effects on the appearance, texture, taste or smell of it.

Australian patent nos. 730402 and 734421 disclose methods of applying a gas mixture comprising a volatile substance such as a biocide and carrier gas, to a foodstuff. The gas mixture, when partitioned to the surface of the food acts to reduce the microbial content on the surface of the foodstuff to reduce spoilage and extend shelf life. However, there are significant difficulties in actually applying the gas mixture to the foodstuff and ensuring a satisfactory partitioning process, particularly in relation to workplace safety, dew point control, uniformity of gaseous biocide/food contact, food safety, advances in Hazard Analysis Critical Control Points (HACCP) auditing, efficiency and materials compatibility, overcoming geographical protection from food and processing equipment contact surfaces, vapor monitoring then subsequent final process control calculations and extrapolating process parameters from a food to another food. What is needed is a better understanding of the biocide gaseous science and a commercially viable and reproducible method of applying this better understanding of gaseous biocides to a foodstuff.

Also, there is a need to consider each biocides' mechanism of operation and reactions relevant to the perishable food being treated and the processing environment that the perishable food is being treated in to determine the order of partitioning, concentrations and ratios of the individual biocides selected relative to each other. A system and process is required to partition the biocide/s to the food that can be performed safely, accurately, repeatably, without damage to the food and equipment, and cost effectively at commercial volumes.

Preferred embodiments of the invention seek to address issues with the prior art, and/or provide a useful alternative.

### SUMMARY

According to a first aspect of the invention there is provided a system for applying a gaseous biocide to a foodstuff, comprising:
a treatment chamber, preferably insulated, having a vapor partitioning passage disposed therein and in which the biocide is applied to the foodstuff;
a conveyor for conveying the foodstuff, the conveyor extending from a first location outside of the treatment chamber, through a first aperture in a wall of the treatment chamber, through the vapor partitioning passage, through a second aperture in a wall of the treatment chamber, and terminating at a second location outside the treatment chamber;
an air distribution system configured to supply air into the treatment chamber, and
an air extraction system through which air and remaining biocide is drawn from the treatment chamber;
wherein the first and second apertures are sized to allow the foodstuff and air from outside of the treatment chamber to pass therethrough and ends of the vapor partitioning passage are spaced from the first and second apertures, and
wherein air pressure within the treatment chamber is maintained lower than that outside the treatment chamber and lower than that within the vapor partitioning passage, whereby air drawn into the treatment chamber from outside thereof is directed away from the vapor partitioning passage and gaseous biocide is prevented from exiting the treatment chamber.

According to a preferred embodiment of the invention, an air pressure just outside of ends of the vapor partitioning passage is lower than that within the vapor partitioning passage to reduce air drawn into the vapor partitioning passage.

Preferably, wherein the air distribution system is configured to maintain the temperature of surfaces in the treatment chamber above a dew point of the biocide. Preferably, the conveyor has upper and lower sections, the upper section passing through the vapor partitioning passage and the lower section passing through a stream of heated air from the air distribution system, whereby a temperature of the conveyor is maintained above a dew point of the biocide to vaporise partitioned or condensed biocide incident thereon. Condensed biocide droplets have a similar concentration as the liquid biocide vaporised e.g. 35% hydrogen peroxide which can negatively impact the food and equipment.

Preferably, within the vapour partitioning passage the gaseous biocide is applied to the foodstuff via a plurality of distribution manifolds, the distribution manifolds being disposed above and below the conveyor preferably in an alternating arrangement and extend transversely across the conveyor, in alternating directions and preferably the angle of impingement of the vapor to the food can be altered.

The system can further comprise a cover or shroud around the first and second apertures formed in a wall of the treatment chamber, the cover/shroud forming additional apertures through which the foodstuff must pass to reach the vapor partitioning passage.

The system can have three or more biocide vessels, each containing one of hydrogen peroxide (HP), acetic acid (AA) or peracetic acid (PAA) and a separate water vessel, the system being configured to vaporise a single biocide or combinations of different biocides, with or without vaporising water.

The system can further comprise a vaporisation chamber remote from the treatment chamber and in which vaporisation of the biocide occurs, the vaporisation chamber having:
an air inlet through which air is drawn into the vaporisation chamber;
a plurality of vessels in which biocides are stored;
liquid chemical metering pumps, and
a vaporiser in communication with the vessels for generating the gaseous biocide, the gaseous biocide being conveyed within a gaseous biocide conduit.

Alternatively, the plurality of vessels are external to the vapour chamber.

Preferably, the vaporiser has a heated air inlet receiving heated air preferably from a low pressure blower and at least one biocide liquid inlet.

Preferably, the gaseous biocide exits the vaporiser at around 100 to 250 degrees Celsius and the gaseous biocide conduit is enclosed in an outer conduit that is in communication with a dew point control air blower preferably within the treatment chamber to contain any vapor escaping the gaseous biocide conduit and reducing the temperature of the gaseous biocide whilst pre-heating air for dew point control.

The system can further include a monitoring system, preferably comprising two sub systems which monitor two feedback signals, one from a measurement of vapor concentration, primarily confirming the presence of gaseous biocide and one from the biocide dosing pumps primarily confirming the specified mass of biocide has been supplied for vaporisation, both systems can continually reference each other to improve accuracy and repeatability. The monitoring system being configured to determine the amount of biocide (and water where used) vaporised per unit time and for inputted parameters relating to production rate mm2/min, liquid biocide concentration, and % partitioning efficiency, outputting a partitioned surface concentration and referenced against the mg/mm2 surface area set point to control the process. In this configuration the monitoring system can calibrate the gas sensors thus reducing operating costs.

The system can have at least one vaporiser which may have at least one vaporisation tray to protect the vaporiser surfaces from the corrosive biocide and/or water that may have not been completely vaporised in the biocide supply tubing which is in direct communication with the heated air and vaporiser and any contained vaporisation vessels' heated surfaces. The vaporisation trays may be formed of Borosilicate or Pyrosilicate glass and may have glass bumping beads to increase the liquid surface area.

According to another aspect of the invention there is provided a method for reducing the microbial content on the surface of a foodstuff which is susceptible to microbial spoilage, the method comprising the steps of:
providing a system of the above described type, and
vaporising the biocide and applying it to the foodstuff.

Preferably, a flow rate of air used for vaporisation of the biocide is increased until the desired mass of biocide that can be vaporised into the air supply to achieve the required foods' uniform surface biocide mg/mm2 concentration.

The method can further comprise the step of increasing a mass of surface water on the foodstuff prior to or whilst applying the biocide.

Preferably, the biocide is an acid and initial pH of the biocide vapor partitioned on the surface of the foodstuff is in the range of 0.8 to 4.50 in the presence of peracetic acid at a surface mass in the range of 0.000001 mg/mm2 to 0.08 mg/mm2.

Preferably, the biocide is an acid and a pH of the biocide vapor partitioned on the surface of the foodstuff in the range of 0.8 to 4.50 in the presence of hydrogen peroxide at a surface mass in the range of 0.00001 mg/mm2 to 0.08 mg/mm2

The gaseous biocide may be comprised of two or more individual biocides, applied to the foodstuff in overlapping or separate steps.

Preferably, the biocide is applied to the foodstuff such that a final surface concentration of the biocide on the foodstuff is in the range of:
0.0001 to 0.09 mg/mm2 for acetic acid;
0.000001 mg/mm2 to 0.08 mg/mm2 for peracetic acid; or
0.00001 mg/mm2 to 0.08 mg/mm2 for hydrogen peroxide.

More preferably, a surface concentration of the biocide on the foodstuff is in the range of:
0.001 to 0.029 mg/mm2 for acetic acid;
0.00001 mg/mm2 to 0.015 mg/mm2 for peracetic acid;
0.000026 mg/mm2 to 0.015 mg/mm2 for hydrogen peroxide.

In some embodiments, the biocide includes peracetic acid and hydrogen peroxide applied to the foodstuff such that a final surface concentration of each biocide on the foodstuff is in the range of:
a. hydrogen peroxide from 0.00001 mg/mm2 to 0.08 mg/mm2;
b. peracetic acid from 0.000001 mg/mm2 to 0.08 mg/mm2.

In some embodiments, the biocide includes acetic acid and hydrogen peroxide applied to the foodstuff such that a final surface concentration of each biocide on the foodstuff is in the range of:
a. 0.0001 to 0.09 mg/mm2 for acetic acid;
b. 0.00001 mg/mm2 to 0.08 mg/mm2 for hydrogen peroxide.

In some embodiments, the biocide includes peracetic acid and acetic acid applied to the foodstuff such that a final surface concentration of each biocide on the foodstuff is in the range of:
a. 0.000001 mg/mm2 to 0.08 mg/mm2 for peracetic acid;
b. 0.0001 mg/mm2 to 0.09 mg/mm2 for acetic acid.

In some embodiments, the biocide includes peracetic acid, acetic acid and hydrogen peroxide applied to the foodstuff such that a final surface concentration of each biocide on the foodstuff is in the range of:
a. peracetic acid from 0.000001 mg/mm2 to 0.08 mg/mm2;
b. Acetic acid from 0.0001 to 0.09 mg/mm2; and
c. hydrogen peroxide from 0.00001 mg/mm2 to 0.08 mg/mm2.

Preferably, after processing the foodstuff is stored in low vapor permeable vessels with or without the presence of visible liquid.

According to another aspect of the invention there is provided a method for reducing the viable microbial content on the surface of a foodstuff which is susceptible to microbial spoilage, the method comprising the steps of:
entraining a volatile substance in a stream of a carrier gas to form a gaseous biocide, the volatile biocide substance being selected from the group of acetic acid, peracetic acid, hydrogen peroxide, or combinations thereof;
applying the gaseous biocide to the surface of the foodstuff,
whereby an initial surface concentration of the biocide on the foodstuff is:
   in the range of 0.0001 to 0.09 mg/mm2 for acetic acid, when used;
   in the range of 0.000001 mg/mm2 to 0.08 mg/mm2 for peracetic acid, when used; and
   in the range of 0.00001 mg/mm2 to 0.08 mg/mm2 for hydrogen peroxide, when used.

Preferably, the gaseous biocide includes peracetic acid, hydrogen peroxide and acetic acid, individually or any combination and is formed from:
liquid peracetic acid having a concentration of less than 15% w/w;
liquid acetic acid having a concentration of less than or equal to 72.5% w/w; and
liquid hydrogen peroxide having a concentration of less than or equal to 35% w/w,
wherein the total acetic acid vapour concentration from a vapour mixture of peracetic acid and acetic acid is preferably below 24 mg/L and the method is suspended if there is detected an increase in acetic acid concentration, possibly indicating heat related degradation of peracetic acid.

### BRIEF DESCRIPTION OF THE DRAWINGS

In order that the invention may be more easily understood, an embodiment will now be described, by way of example only, with reference to the accompanying drawings, in which:

FIG. 1 is a schematic view of a system for applying a gaseous biocide to a foodstuff according to a preferred embodiment of the invention;

FIG. 2 is a graph showing Acetic Acid partitioning efficiency for various sausage formulations;

FIG. 3 is a graph showing results of a challenge study in which AA was partitioned to a cooked sausage product, and

FIG. 4 is a table showing parameters of trials in which acetic acid and hydrogen peroxide were partitioned to a mandarin.

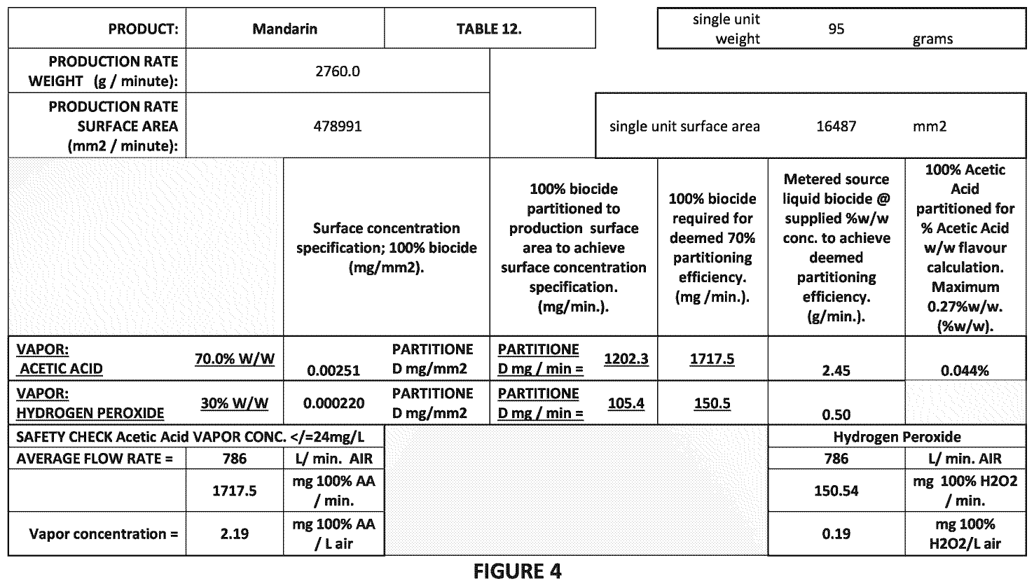

### DETAILED DESCRIPTION OF THE DRAWINGS

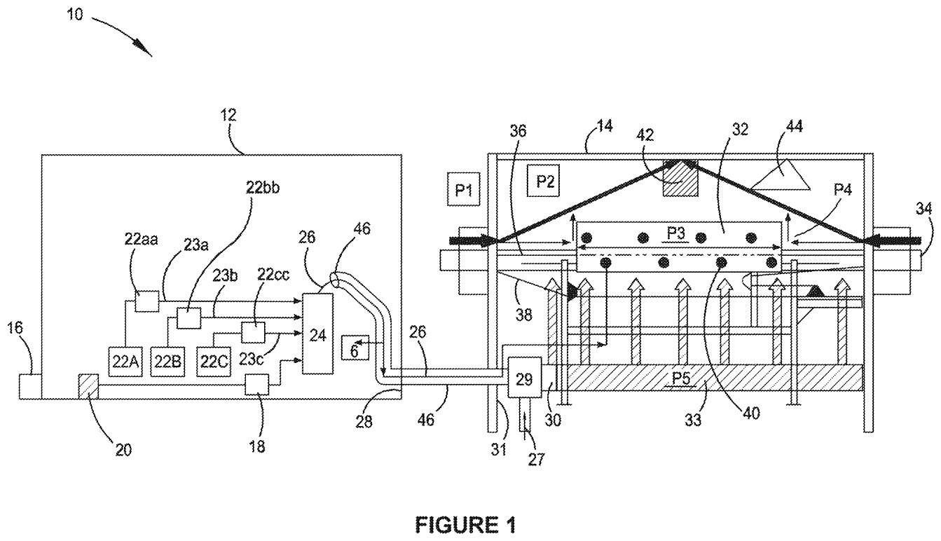

A system 10 according to a preferred embodiment of the invention is shown schematically in FIG. 1. The system 10 is configured for applying a gaseous biocide to a foodstuff.

The system 10 includes a first chamber 12 and a second chamber 14. In the first chamber 12 vaporisation of the biocide occurs. In the second chamber, also referred to as a treatment chamber, application of the gaseous biocide to the foodstuff occurs. Providing the system in two chambers allows for a modular construction while maintaining separated, contained biocides, which can be dangerous chemicals, preferably external to the workspace.

Those skilled in the art will appreciate that although the system is shown as having two chambers, the invention may be implemented in a single chamber, in accordance with the claims.

The first chamber 12 has a blower 20, fitted with a filter, in communication with a heater 18 to supply a specified volume of heated air into vaporiser 24. Blower 20 draws air through inlet 16, which is also filtered. It will be appreciated that the location of the blower 20 may vary and also that different types of devices for moving air, such as compressors or fans, may be used.

In the described embodiment, the heated air is heated to a temperature sufficient to vaporise the specified liquid biocide flow rate in biocide supply tubes 23a, 23b, which are preferably formed of PFA, in the range of preferably 120 degrees Celsius to 400 degrees Celsius. The heated air is preferably at or below 260 degrees Celsius when in communication with PFA tubing that has insufficient liquid phase to maintain the PFA tube at or below 260 degrees Celsius.

Within the first chamber 12 are three pumps, preferably enclosed, 22aa, 22bb, 22cc in which biocides are metered to achieve a desired mg/mm2 surface concentration specification. It will be appreciated that the first chamber 12 may include one, two, three or more pumps. In the described embodiments, one pump is configured for HP, another for AA and another for PAA. It is possible that other biocides may be suitable for use in the described system and method.

Within the first chamber 12 is also a vaporiser 24 (described further below). The vaporiser 24 is in communication with and receives biocide from the pumps 22aa, 22bb, 22cc for generating the gaseous biocide. The gaseous biocide is conveyed from the vaporiser 24 within a gaseous biocide conduit 26. Conduit 26 is disposed within air conduit 46, at least partially along its length, air conduit 46 being configured to supply air to the second chamber to control the dew point of the biocide.

It will be appreciated that the temperature of the gaseous biocide exiting the vaporiser may be quite high, for example around 110 to 250 degrees Celsius. To cool the gaseous biocide prior to application to a foodstuff, the gaseous biocide conduit 26 resides within the dew point control air conduit 46 within the first chamber 12, conduit 46 terminates into blower 29 for distributing the dew point control air, for reducing the temperature of the gaseous biocide. With such an arrangement, heat from the gaseous biocide pre-heats the dew point control air, thereby increasing overall process efficiency.

It will be appreciated that for extended distances separating the first and second chambers 12, 14, the air flow surrounding conduit 26 may have to be reduced so as to maintain the gaseous biocide above its' dew point. In one embodiment blower 29 can source some of this specified air volume, preferably external to chamber 14 via inlet 27, not disturbing the two air flows into chamber 14. Conduit 26 may include heating such as electrical heat tracing. Conversely conduit 26 must be designed to provide sufficient cooling over shorter distances.

The second chamber 14 is preferably insulated and has an inlet 31 in communication with conduits 26 and 46 blower 29, then heater 30 then conduit 33 for receiving dew point control air from the first chamber 12 via outlet 28. The gaseous biocide conduit 26 extends through the conduit 46, should conduit 26 fail the gaseous biocide cannot escape into the workspace and is contained in conduit 46. Gaseous biocide is maintained above its dew point temperature.

Within the second chamber 14 is a vapor partitioning passage 32 in communication with the gaseous biocide conduit 26. Within the vapor partitioning passage 32, the gaseous biocide is applied to a foodstuff. The warm biocide vapor is at a temperature which is greater than the dew point and assists with the heating above the vapor dew point of the internal surfaces in the vapor partitioning passage 32.

A conveyor belt 34 is also disposed in the second chamber 14, the conveyor belt 34 having an upper section 36 and a lower section 38. The conveyor belt 34 is configured to convey the foodstuff to facilitate application of the gaseous biocide. To facilitate this, the upper section 36 passes through the vapor partitioning passage 32 and the lower section 38 of the belt passes external to vapor partitioning passage 32 through a stream of heated dew point control air from the heater 30 and conduit 33 to dry and warm the lower section 38 of the belt and all surfaces within chamber 14, especially materials that are not compatible with condensed liquid biocides to a temperature determined as a function of the air velocity and total surface area, preferably around 52 degrees Celsius. The lower vapor temperature exiting the vapor passage and the preferably lower temperature external air inrush protect the food from the heated dew point control air.

The conveyor belt 34 is formed of a perforated material which allows the heated air and biocide vapor to pass through and heat the belt. Preferably, the conveyor belt 34 is formed of an open mesh stainless steel, more preferably using the thinnest gauge wire possible and having the largest spacing between wires. Not only does this allow the heated air to pass through and heat the lower belt and all surfaces in chamber 14 but in the upper section 36, flow of the gaseous biocide is minimally impinged and maximises contact with the food.

By heating the conveyor belt 34, the gaseous biocide substantially does not condense when it contacts the belt, which could cause it to collect thereon and negatively impact the food. The biocide remains in the gaseous phase until it contacts water or a surface below the dew point temperature of the gaseous biocide. As the belt 34 has been dried and warmed by the heated air there is negligible partitioning of the biocide to the belt which helps to maintain the preferred concentration of the gaseous biocide and control of the process.

For all practical purposes, gaseous biocide partitioning is to the surface of the food and the foods' belt wetted and/or cooled interface only. In this manner the food is accurately and consistently treated even at the belt/food interface. Without dew point control the process cannot sustain its' technological goals and is not commercially viable. Any food wetted or cold belt or other intentionally water wetted or cold equipment will have biocide/s partitioned to its' surface which will also maintain equipment sanitation of the process as it continues and of slicing knives etc in other vapor partitioning passages and achieves biocide partitioning under leaf structures on fresh produce etc. Owing to such a configuration, the described system is at least partially self-sanitising. Where further cleaning is desired, water may be sprayed onto the conveyor and the system run without foodstuffs to allow the biocide to partition to the conveyor, thereby sanitising it. Such an arrangement is particularly beneficial where the foodstuffs leave residue on the conveyor, such as in the processing of small goods.

In the illustrated embodiment, dew point control air is distributed evenly by the conduit 33 under the vapor partitioning passage 32 and the lower section 38 of the conveyor belt 34 and extending, preferably, the full length of the vapor partitioning passage effectively heating the entire length of lower section belt 38 and vapor partitioning passage 32. The conduit 33 has an open upper outlet which may be fitted with diffusers to distribute the air stream and facilitate flow of the air generally evenly through the lower conveyor belt 38 heating all equipment and chamber surfaces to above the dew point of the gaseous biocide.

On the upper section 36 of the belt, the foodstuff is placed so as to travel through the vapor partitioning passage 32. In the passage 32, the gaseous biocide is applied to the foodstuff via a plurality of distribution manifolds 40. The distribution manifolds 40 are disposed above and below the upper section 36 of the conveyor 34 in an alternating arrangement. Preferably, the manifolds 40 extend transversely across the conveyor, in alternating directions, i.e., a first manifold may extend right to left with an adjacent manifold extending left to right. This is done to minimise the effect of any variation in gas flow velocity between a start and end of the manifold. Manifolds are preferably adjustable so as to change the angle of impingement of the gaseous biocide to different food surfaces e.g. round blueberries to flat top and bottom mandarins. The flow of gaseous biocide from each manifold 40 within the vapor partitioning passage 32 is preferably at least 20, more preferably 40 to 80 litres per minute per 260 mm length of manifold. Vapor manifold outlet hole size, spacing and angle of the vapor manifold relative to the food is a function of vapor flow rate and backpressure to achieve an even velocity and continuous air vapor curtain along the length of the manifold whilst uniformly contacting the food.

Diffusers may be installed within the vapor partitioning passage 32 to facilitate even distribution and multiple passes of the gaseous biocide around the food as it exits the vapor partitioning passage. The vapor partitioning passage 32 is saturated with biocide vapor and the resultant internal pressure P3 minimises inrush of external air, which is now at a reduced velocity due to the placement of the air extraction 42, from negatively impacting the vapor partitioning process inside vapor partitioning passage 32.

It can be appreciated that the vapor partitioning passage 32 can be configured differently, but vapor flow, air flows and condensation management as above will be required.

The second chamber 14 also has an outlet 42 through which air within the chamber (the heated dew point control air and air entering from external of the chamber) and gaseous biocide is drawn. The outlet gas is passed through a water scrubber to remove any biocide before the air is discharged to the atmosphere. The water scrubber has its' own fan which, in conjunction with blowers 20 and 29, control the movement of the three air streams into, through and out of system 10.

Given the known occupational exposure safety issues with biocides, it is important that the gaseous biocide be retained within the second chamber 14. To facilitate this, the pressure P2 within the second chamber 14 is lower than that outside the chamber P1 so as to draw air into the chamber from outside and prevent biocide escaping. The second chamber air extraction outlet 42 is positioned to rapidly remove the air to prevent it from disturbing the vapor flow around the food. The distance from each end of the vapor partitioning passage 32 and the inlets and outlets that the external air flows into chamber 14 is important. At each inlet and outlet there is provided an extension of the chamber in the form of a conduit or shroud to form a second opening through which the food stuff passes. This may ensure that no gaseous biocide can escape chamber 14 and enter the workspace from these points. Chamber 12 is engineered not to have any leakage of gaseous biocide but has a negative pressure due to the air for vaporisation blower 20 and conduit 46.

An air curtain of sterile air encapsulating the conveyor, food and external outlet of chamber 14 will reduce air borne contaminants that can react with the partitioned biocide/s on the treated food thus extending the post process protection. The following examples were not performed with this sterile air curtain, demonstrating the substantial post process protection afforded by the inventive process. High surface biocide concentrations can be programmed to remain up to at least one hour. Heated dew point control air and the air for the vaporiser can be sourced from surplus air from the sterile air curtain.

Combining acid biocide vapors, which are a combustible fuel, with oxidant vapor biocides can form an explosive mixture. Safety audits were conducted using independent experts whose combined advice concluded that the fuel and oxidant biocides in the current invention could be mixed under the following conditions which ensure sufficient water vapor is present and minimal fuel concentrations to negate an explosion risk. An effective process is still maintained:
I. Vapor generated by heating preferably liquid less than or equal to 35% w/w HP is not an explosion risk
II. Vapor generated by heating less than 15% w/w liquid PAA is not an explosion risk
III. Vapor generated from heating preferably liquid less than or equal to 35% w/w HP and vapor generated from heating less than 15% w/w liquid PAA can be vaporised together and the resultant vapor is not an explosion risk
IV. AA liquid is not flammable if diluted to 72.5% w/w or less
V. Vapor generated from heating less than 72.5% w/w liquid AA is not an explosion risk
VI. Vapor generated from heating less than 72.5% w/w liquid AA and at a maximum vapor concentration, preferably of 24 mg/L, which is 20% of the LEL and H2O2 vaporised from a maximum liquid concentration of preferably 35% w/w and PAA vaporised from less than 15% w/w liquid can be vaporised together and the resultant vapor is not an explosion risk.
VII. The SDS for 15% w/w PAA stating ‘PAA can cause a fire’ was clarified with the chemical manufacturer/supplier. PAA will only cause a fire if it continuously comes in contact with a combustible material, the PAA molecule degrades and the resultant HP concentration increases to close to 70% w/w and the combustible material ignites. Liquid PAA does not come in contact with combustible materials in the current system and method.
VIII. The current invention also recognises that if the flash vaporisation rate of less than 15% w/w liquid PAA substantially decreases, the masses of HP and AA from the PAA degradation in combination with any added less than 72.5% w/w liquid AA and/or any added, preferably 35% w/w or less liquid HP may lower the AA LEL and reach an explosive concentration. The system will meter more PAA to compensate for the PAA concentration decrease due to the heat degradation. To mitigate this risk PAA liquid at less than 15% w/w will be flashed vaporised, preferably by itself in a separate vaporiser, with multiple sealed chambers or multiple separate trays. The total AA vapor concentration from any vapor mixture of PAA and AA will preferably be not greater than 24 mg/L, without further investigation. Any decrease in PAA concentration or increase in HP or AA concentrations greater than specified, the process will automatically shut down, which would also occur for food safety reasons. Shut down automatically stops heating of the vaporiser/s and supply of liquid biocides, liquid water may start or continue, whilst continuing supply of air for vaporisation thus negating any increase in biocide concentrations. Excess vaporisation heat energy and/or heat transfer area are supplied to ensure the flash vaporisation of the less than 15% w/w liquid PAA.

The second chamber is also provided with a water based fogging system 44 for an emergency system shutdown.

System 10 can further include a monitoring system 6, preferably comprising two sub systems. Two feedback signals, one from a measurement of vapor concentration, primarily confirming the presence of gaseous biocide and one from the biocide dosing pumps primarily confirming the specified mass of biocide has been metered for vaporisation. The monitoring system being configured to determine the amount of biocide (and water where used) vaporised per unit time and for inputted parameters relating to production rate mm2/min, liquid biocide concentration, and % partitioning efficiency, outputting a partitioned surface concentration and referencing against the mg/mm2 set point to control the process.

Having determined and compared the biocide surface concentration to the mg/mm2 setpoint a control loop can be used to control the mass of liquid biocide metered for vaporisation, air for vaporisation flow rates, any degree of drying of the air for vaporisation to maintain the desired biocide food surface concentration and adjust for changes in production rate or surface area variations of foods. Without knowing and controlling all of these variables the food safety of the food over the extended shelf life will be compromised if the surface concentration is reduced too much. Visual quality of the food and/or flavour will be degraded if the surface concentration is too great. This system also largely negates the need for continual pump calibration and compensates for general system variances. The partitioning efficiency of oxidants cannot be determined due to their rapid rate of degradation. It is deemed to be high, most likely, 70% due to very little apparent difference in degradation rates between relatively dry and clearly wet food surfaces and different surface concentrations greater than the breakpoint concentration. A deemed partitioning rate still permits the process to be controlled and is relative so as to extrapolate an established process to a new food process. Unless otherwise specified all surface concentrations expressed as mg/mm2 have used a deemed partitioning efficiency of 60%.

In one embodiment, there are numerous vapor concentration measurement mechanisms for monitoring system 6 which are preferably disposed in the second chamber 14. A water dilution method includes a sampling line branching off from the gaseous conduit 26 for conveying the gaseous biocide to a water dilution step. Known continuous flows over liquid sensors can measure the mass of biocide in the water and the mass of liquid biocide vaporised per unit time can be back calculated.

In another embodiment in-line vapor sensors such as PIDs, VOCs or pellistors can be used to calculate of the mass of biocide vaporised per unit time. These three can be used in conjunction to differentiate and control any combination of AA, HP and PAA.

Contained within the three vessels 22a, 22b, 22c is one of HP, AA or PAA. The three vessel installations are each designed so as to contain any leakage should a vessel fail. To permit close storage of incompatible biocides within either chamber 12 or 14 in the workspace the biocides are stored in sealable double walled vessels. In another aspect biocides may be stored in bulk vessels, preferably external to the workspace to reduce replacement frequencies. Liquid PAA storage may require cooling. The biocide pumps, preferably are also enclosed in case of failure.

The system 10 is configured to vaporise a single biocide or combinations of different biocides.

In some examples, the mass of water on the surface of perishable foods is very small. It is estimated that a 5244 mm2 surface area low Aw Frankfurt has an ‘original’ surface water mass down to approximately 0.000006 mg/mm2 in its' ‘original’ closed system Equilibrium Relative Humidity state. For many foods the lowest mass of partitioned biocide (as mg/mm2) is approximately 10 times, and the greatest mass can be 10000 times the estimated 0.000006 mg/mm2 of ‘original’ surface water, which explains the high partitioned surface concentrations achieved, sometimes in excess by test strip of 1000 mg/l for oxidants and pH down to approximately 0.8 for acids. These surface concentration ranges, preferably in mg/mm2 are fundamental in understanding and controlling the current invention. However, especially for a non-degrading biocide such as AA, excess free water on the surface can be present and the process can still be effective, until the mass of free surface water increases and the surface biocide concentration decreases such that the process efficacy does not achieve the technological goals. Biocides, especially oxidative biocides, that quickly degrade to less effective chemicals are effected to a greater degree by excessive surface water concentrations.

On completion of the partitioning of biocides and some of their water plus some water from the air for vaporisation, insufficient surface water mass typically results and a colour reaction cannot be achieved on test strips normally used to test the concentration of these biocides in water-based technologies. Test strips are pre-wetted, preferably with de-ionised water, excess removed, in order to obtain a diluted estimate of partitioned surface concentration in mg/L.

Techniques are currently not known to man to accurately quantify the minimum mass of water on the surface of a perishable food. Excessive water can be visually identified and can result in undesirable physical, chemical, flavour impacts and a reduction in process lethality. Generally, the greater the mass of surface water the greater the rate of partitioning. Partitioning of a biocide with a greater mass of water as a first step, can increase the partitioning rate of a biocide with a lower mass of water partitioned simultaneously, as a partially overlapping or second separate step. Adding water or partitioning water vapor only as a first step can increase the partitioning rate of a biocide with a lower mass of water partitioned simultaneously, as a partially overlapping or separately as a second step and will permit partitioning of biocide/s to a food, perishable or not, with insufficient mass of surface water to permit effective biocide vapor partitioning such as whole eggs in shell or beef jerky.

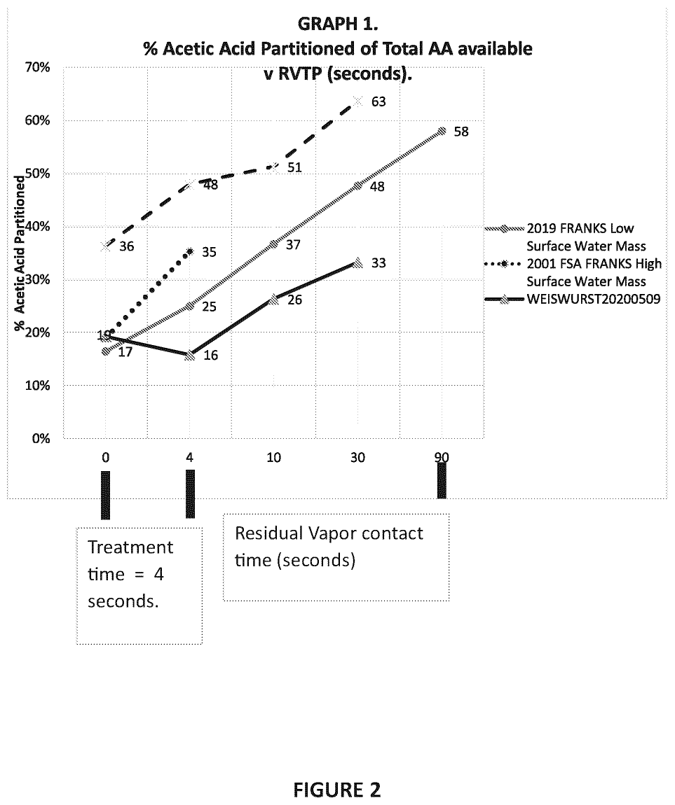

The rate of partitioning of a biocide to a foodstuff is a major determining factor for: calculating the surface concentration of a biocide preferably in mg/mm2; ensure maximum process lethality; designing a suitable manifold system to ensure sufficient vapor contact time with the food, determining processing rate of the food; optimising the cost contribution of the biocides; extrapolate a process from one food to another, ensuring food quality is not degraded; and validate a process change. In general acids, especially AA, require approximately 10 times more time in contact with the biocide gas to achieve the same % partitioning efficiency, as the usage rate is generally 10 times greater. All prior research which is typical of the prior art was conducted in plastic vessels and/or vessels with no dew point control which typically result in the need for greater gas concentrations and loss of process control also resulting in approximate biocide cost contributions of 1 to 3 cents/Kg of finished product. Embodiments of the present invention have reduced the biocide cost contribution down to 0.04 cents/Kg of finished product by ensuring there is no condensation on any surface other than the food being treated and its' immediate equipment contact wetted surface and greater uniformity of biocide gas contact with the food. Future manifold development will further increase % partitioning efficiency. Equipment with materials of construction in system 10 that corrode when contacted by liquid acids and oxidants, which are not readily available ‘off-the shelf’ in non-corrosive materials include insulation panel painted surfaces, IP00 non protected open motors and geared drives, and galvanised air handling ducting such as outlet 42. Dew point control achieved by the inventive process, including controlled temperature startup and shutdowns, has permitted these surfaces to be in direct contact with the gaseous biocides for in excess of 400 operational hours with no failures or visible signs of corrosion. The rate of partitioning or % partitioning efficiency can be determined by partitioning to the food, under the process conditions, a non-degrading biocide such as AA and determining its partitioned concentration at varying total vapor contact times. A partitioning time V % efficiency graph is generally accurate enough to facilitate most functions. Refer to the graph of FIG. 2 for partitioning efficiencies for various sausage formulations.

As the mass of water vapor in a biocide vapor increases the mass of biocide/s that can be vaporised decreases. In some instances, partial removal of water vapor from the air for vaporisation may be required. Blowers are the preferred method of air supply due to their lower energy requirement but operate at a low pressure not compatible with conventional air dryers but compatible with the low vapor phase operating pressures. Low-pressure air dryers can be used but have greater operating costs. Monitoring system 6 can be used to minimise any energy required to dry the air supply to permit vaporisation by controlling the degree of drying to just that required to maintain the required surface biocide mg/mm2 concentration of the food or the air flow rate can be increased to lower the vapor concentration whilst maintaining the mass of biocide vaporised per unit time or the final vapor temperature exiting the manifolds can be increased, preferably by reducing the degree that the hot vapor exiting the heat vaporiser is cooled. The current invention preferably does not generate oxidant vapor concentrations above 5 mg/l, preferably 2 mg/l to minimise the influence of water vapor and the mass of oxygen liberated. Lower oxidant concentrations also help to align oxidant and acid gas contact times thus improving uniformity of biocide partitioning. The subsequent increased air volume to maintain the required mass of biocide is efficiently supplied by low-pressure air blowers thus substantially reducing the carbon footprint of the invention. It is preferable to reduce the distance between the manifolds for these lower vapor concentrations to ensure the oxidants, particularly PAA are still partitioned quickly to achieve maximum surface concentration. Blowers will increase the air temperature, typically to 50 Degrees Celsius, which will decrease the total energy requirement of the heat vaporiser and the heater for the dew point control air.

An optimum mass of surface water will exist for partitioned biocides to achieve a maximum microbial reduction. On determination of the latter, the total mass of water added to the original natural mass of water could be achieved by controlling the mass of water vapor in the vapor air supply and/or the mass of water in the biocides as well as order of partitioning, partitioning rate and other variables as previously described. Conversely, a food may have too great a mass of surface water and may require drying.

To determine a vapor phase Food Safety process for a given food to achieve an extended shelf life the following variables, as a minimum, are considered and manipulated: Selection of appropriate biocides, Target surface concentration/s extrapolated from similar foods preferably in mg/mm2, Production rate as mm2/minute, % partitioning efficiency, Order of individual biocide partitioning or combined gas, Degree of post process protection, Total time food will be in contact with the vapor, Minimum number of manifolds to ensure maximum mass of biocide/s are partitioned, Mass of biocide vaporised per unit time, For AA preferably partition as a first step at 10.6 mg/l to achieve a minimum acceptable % partitioning efficiency, Maximum safe vapor concentration for fuels, Oxidants preferably at less than 2 mg/l, Maximum biocide vapor concentrations for dew point control, Temperature of dew point control air and subsequent establishment of equipment temperatures to prevent condensation of biocides in chamber 14.

Length and type of vapor partitioning passage dictated by floor space and food type, Liquid biocide concentration, Sufficient vapor volume to ensure uniform flow out of the manifolds and impingement angle; Sufficient volume of vapor to uniformly partition the biocide/s to each foods surface area, Spacing between individual units of food, especially for large items, Sufficient vapor volume to achieve the minimum vapor pressure (P3) and flow out of the vapor partitioning passage, Product volume modifications to inlet and outlet apertures and any subsequent re-balancing of total system 10 air flows, Expected maximum competing water mass in air for vaporisation.

On final determination of an appropriate process, the surface mass of partitioned individual biocides is determined, preferably as mg/mm2, this is the process set point. This process is then scaled up to commercial quantities by inserting the process set point (mg/mm2) of individual biocides into the front end of the process controller to determine the required mass of biocide to be vaporised as mg/minute for the foods' production rate (mm2/minute), % partitioning efficiency and liquid biocide concentration. This data is then used by the process controller to commence the process when all of the dew point control temperatures are within specification. Final control is confirmed to maintain the specified surface mass of the biocide (mg/mm2), ensuring the safety of the food, desired shelf life and availability of mg/mm2 data for HACCP reporting.

Where AA is used by itself, it is preferably partitioned to a surface concentration in the range of 0.0001 to 0.09 mg/mm2, more preferably in the range of 0.001 to 0.029 mg/mm2.

In use, when used alone the mass of partitioned Acetic for foods with a cross sectional area of less than 50 mm is typically limited by a flavour threshold (in the absence of masking flavours or alkaline neutralising substances) of 0.3% w/w of the mass of the product being treated, with the partitioned AA diluted through the continuous water phase of the perishable food.

PAA may be used by itself. The mass of PAA alone that can be partitioned to the surface of a perishable food is limited by oxidative chemical reactions (from both PAA and HP) that result in a detrimental physical or flavour impact on the perishable food. This is typically lipid rancidity which in most cases is evident well after the non-vapor phase shelf life has expired. Secondly, but usually of no quality concern are chemical, physical and flavour impacts from the AA contributed by the PAA.

Preferably, the surface concentrations of peracetic acid on the foodstuff range from 0.000001 mg/mm2 to 0.08 mg/mm2, more preferably from 0.00001 mg/mm2 to 0.015 mg/mm2.

Surface concentrations, by test strip, of PAA greater than 1000 mg/l, which is the upper detection limit of test strips used, can be achieved without detriment to the perishable food due to the greater uniformity, accuracy and lack of large masses of PAA in residual surface water droplets of non-vapor phase liquid chemistry processes. Of major significance is the small surface water mass resulting in the partitioned undiluted PAA having similar but transient chemical properties of the liquid PAA vaporised. Partitioned PAA not or marginally diluted achieves greater efficiencies over traditional liquid PAA wash technologies as the pH of the source liquid PAA used to generate the PAA vapor will, for all practical purposes, not be diluted. For 15% w/w PAA this pH is <2.0. However, as the partitioned AA mass from the PAA is typically relatively small when compared to an AA vapor only process, the high surface acidity is relatively transient compared to an AA vapor only process. Introduction of AA only vapor to increase the mass and the amount of time the high surface acidity is maintained will optimise the microbial lethality of the PAA.

PAA molecules are very unstable and a substantial mass of the PAA generally degrades within 90 seconds depending on the foods' surface chemistry e.g., presence of oxidisable chemicals such as iron. Addition of partitioned HP vapor will extend the oxidative microbial lethality of PAA. Additions of either HP vapor or AA vapor, especially if partitioned first, to the PAA vapor treatment process, either simultaneously or at separate or partially overlapping process steps can increase the PAA residual times, lethality and post process protection. Which oxidant performs the greater majority of the ‘break point reduction’ will be a function of a number of variables, the general preference is for the HP to perform the greater majority of the ‘break point reduction’. Some strawberry varieties have a HP ‘breakpoint’ of 0.0006 mg/mm2 at deemed 70% partitioning efficiency before a 100 mg/l surface concentration is achieved and maintained for at least 25 minutes indicating substantial post process protection. Typically this has degraded to 5ppm at 60 minutes.

The mass of HP alone that can be partitioned to the surface of a perishable food is limited by oxidative chemical reactions that result in a detrimental physical or chemical impact on the perishable food (this is typically lipid rancidity which in most cases is evident well after the non-vapor phase shelf life has expired). Also, HP typically results in a greater bleaching or ‘whitening’ impact per unit partitioned mass than PAA and this must be investigated for each perishable food and if necessary, partition some PAA to offset this bleaching impact whilst maintaining a viable oxidative treatment.

Additionally, some countries, such as Australia and New Zealand for example, have a maximum residue limit (MRL), 5 mg/kg specifically for HP, as set by SFANZ. This can be managed, if necessary, by the addition of PAA vapor, contributing a lower total mass of HP to achieve the same oxidative technological goal.

Suitable surface concentrations of hydrogen peroxide range from 0.00001 mg/mm2 to 0.08 mg/mm2, preferably 0.000026 mg/mm2 to 0.015 mg/mm2.

Surface concentrations by test strip of HP greater than 100 mg/l, which is the upper detection limit of test strips used, can be achieved without detriment to the perishable food due to the greater uniformity, accuracy and lack of large masses of HP in residual surface water droplets of non-vapor phase liquid chemistry processes. Of major significance is the small surface water mass resulting in the partitioned undiluted HP having similar but transient chemical properties of the liquid HP vaporised.

Additions of either AA vapor or PAA vapor to the HP vapor treatment process, either simultaneously or at separate or partially overlapping process steps will increase the lethality and post process protection. Partitioned HP residual times can be increased in this aspect of the invention as any partitioned PAA and AA can react with some of the oxidisable materials thus reducing the breakpoint for the partitioned HP.

A vapor blend of PAA and HP maybe used, either:
I. simultaneously
II. PAA first
III. HP first
IV. separately
V. or partially overlapping process steps

This will increase the process lethality and partitioned residual times of the total oxidant surface concentration or the surface concentration of the oxidant partitioned as a second step either separately or overlapping.

Order of partitioning, concentrations and ratios of the two oxidants relative to each other can be organised in respect to their individual functionalities relevant to the perishable food being treated and the considerations necessary for the processing environment that the perishable food is being treated in. Suitable surface concentrations of hydrogen peroxide range from 0.00001 mg/mm2 to 0.08 mg/mm2, preferably 0.000026 mg/mm2 to 0.015 mg/mm2. More preferably surface concentrations of hydrogen peroxide range from 0.0001 mg/mm2 to 0.008 mg/mm2. Suitable surface concentrations of peracetic acid range from 0.000001 mg/mm2 to 0.08 mg/mm2, preferably 0.00001 mg/mm2 to 0.015 mg/mm2. More preferably surface concentrations of peracetic acid range from 0.0001 mg/mm2 to 0.008 mg/mm2.

As mentioned above, the vaporiser 24 is in communication with each liquid biocide vessel. Multiple vaporisers, each in communication with a biocide vessel may also be provided. It can be desirable to use different biocides, or different combinations of biocides, for different foodstuffs. Having the vaporiser in communication with each vessel allows different biocides to be selectively used and individually monitored as required.

Within the vaporiser may be a plurality of vaporisation trays, or vapor vessels. The trays protect the vaporiser surfaces from the corrosive biocide and/or water that may have not been completely vaporised in the PFA biocide supply tubing allowing for flash vaporisation of any small volumes of remaining liquid biocide sprayed directly onto a respective tray. Due to the corrosive nature of the heated biocides, it will be appreciated that the material used for the trays must be carefully selected. In a preferred form, the vaporisation trays are formed of Borosilicate or Pyrosilicate glass due to the lack of available metal or metal food grade coated surfaces that are not corroded by the biocide vaporisation process. As an example the titanium oxide of grade 7 titanium is visually reduced within hours of vaporising PAA. The inner surfaces of the heat vaporiser are preferably coated with a corrosion resistant coating to offer protection against infrequent, unintentional small masses of liquid biocide that is not contained by the trays. If necessary the coating may have to be not approved for food contact. As the application is non-direct food contact this may be acceptable if the coating e.g. ceramic is heat cured well above the vaporisation operating temperature. To avoid this the PFA supply tube vaporisation is typically operated at only 50% of its capacity.

Following application of the gaseous biocide to the foodstuff, it is preferably packaged in a low vapor permeable, sealed, high humidity package. It has been shown that for the greater majority of perishable foods the optimum shelf life is in a high humidity environment which substantially reduces moisture loss from the treated food thus minimising quality defects such as desiccation crevices and general loss of surface structural integrity. The general result is that the overall physical and microbiological shelf life is actually increased as one of the major causes of microbiological growth, especially in fresh produce, is the loss of surface ‘skin’ structural integrity.

PAA and AA vapor blends may be used, either:
I. simultaneously
II. AA first
III. PAA first
IV. separately
V. or partially overlapping process steps

AA partitioned first is optimum in establishing the greatest surface mass of non-degrading acid for the PAA to partition into. In this way all of the available PAA partitioned is at the optimum or maximum pH/acid mass for the particular process rather than both the acid and the PAA partitioning together starting at a low mass of partitioned acid.

AA partitioned first can also increase the partitioned residual times of the PAA surface concentration as it can react with or bind with some of the substances that could degrade the PAA. AA partitioned first will also lower the AA vapor concentration contacting oxidant vapors partitioned as a second overlapping or separate step.

AA and PAA partitioned simultaneously or as overlapping steps can be the simplest and most cost-effective equipment configuration whilst still achieving the technological goal. Greater masses of partitioned AA and/or PAA to achieve the same result could be required as the PAA is not partitioned into the pre-established greatest mass of acid.

The order of partitioning, concentrations and ratios of the AA and the PAA relative to each other can be organised in respect to their individual functionalities relevant to the perishable food being treated and the considerations necessary for the processing environment that the perishable food is being treated in.

Suitable surface concentrations of peracetic acid range from 0.000001 mg/mm2 to 0.08 mg/mm2, preferably 0.00001 mg/mm2 to 0.015 mg/mm2. More preferably surface concentrations of peracetic acid range from 0.0001 mg/mm2 to 0.008 mg/mm2.

Suitable surface concentrations of Acetic acid in the range of 0.0001 to 0.09 mg/mm2, but preferably 0.001 to 0.029 mg/mm2.

AA and HP vapor blends may be used together, either:
I. simultaneously
II. AA first
III. HP first
IV. separately
V. or partially overlapping process steps

AA partitioned first is optimum in establishing the greatest surface mass of non-degrading acid for the HP to partition into. In this way all of the available HP partitioned is at the maximum pH/acid mass for the particular process rather than both the acid and the HP partitioning together starting at a low mass of partitioned acid.

AA partitioned first will increase the partitioned residual times of the HP surface concentration as it will react with or bind with some of the substances that could degrade the HP.

AA and HP partitioned simultaneously or as overlapping steps can be the simplest and most cost-effective equipment configuration whilst still achieving the technological goal. Greater masses of HP and AA to achieve the same result would be required as the HP is not partitioned into the pre-established greatest mass of acid.

The order of partitioning, concentrations and ratios of the AA and the HP relative to each other can be organised in respect to their individual functionalities relevant to the perishable food being treated and the considerations necessary for the processing environment that the perishable food is being treated in.

Suitable surface concentrations of Acetic acid in the range of 0.0001 to 0.09 mg/mm2, but preferably 0.001 to 0.029 mg/mm2.

Suitable surface concentrations of hydrogen peroxide range from 0.00001 mg/mm2 to 0.08 mg/mm2, preferably 0.000026 mg/mm2 to 0.015 mg/mm2.

AA, PAA and HP vapor blends may be used:
A. To maximise process lethality if a sterile or close to sterile surface was required. Foods such as processed meats can tolerate this degree of chemical impact which can subsequently permit core microbiological count maintenance/reductions of foods manufactured under GMP as the internal preservative systems are not compromised by unacceptably high surface microbiological counts.
B. To maximise post process protection if required relative to a specific processing configuration and degree of environmental contamination.
C. To maximise process lethality and post process protection for a food that exhibited a detrimental impact to one or more of the biocide/s. e.g., strawberries, which are sensitive to most chemical interventions.
   1. Too much acid and the natural red pigment which is pH sensitive will darken and appear over-ripe and soften.
   2. Too much HP and the red pigment will bleach to a lighter red colour and appear under-ripe and potentially become too firm.
   3. Too much PAA and both 1. and 2. above can occur at varying PAA partitioned surface concentrations.

For strawberries no singular biocide can be partitioned and achieve a satisfactory increase in Food Safety with subsequent microbiological shelf-life extensions and achieve an acceptable visual shelf-life extension quality.

A satisfactory increase in Food Safety is achievable by combining HP and AA vapors which would partially negate the impact of the other. Sufficient acid mass was partitioned to ensure occasional low acid strawberries stayed below pH 3.8. This mass of partitioned acid, by itself, was insufficient to have any microbial control but is complimentary to the natural occurring acid in the strawberry. Currently the maximum visual and textural shelf life achieved is 30 days with HP vapor only, but this would not be Food Safe due to the potential growth of acid resistant Salmonella during the extended shelf life at pH greater than 3.8. A guaranteed strawberry shelf life of greater than 8 days (typical historical maximum) is achievable with the addition of AA.

Partitioned PAA vapor, HP vapor and AA vapor could be used either:
I. simultaneously
II. AA first
III. PAA first
IV. HP first
V. separately
VI. or partially overlapping process steps

AA partitioned first is optimum in establishing the greatest surface mass of non-degrading acid for the PAA and HP to partition into. In this way all of the available PAA and HP partitioned is at the maximum pH/acid mass for the particular process rather than the acid, PAA and HP partitioning together starting at a low mass of partitioned acid.

AA partitioned first will increase the lethality and partitioned residual times of the PAA and HP surface concentrations as it will react with or bind with some of the substances that could degrade the PAA and HP.

AA, PAA and HP partitioned simultaneously or as overlapping steps can be the simplest and most cost-effective equipment configuration whilst still achieving the technological goal. Greater masses of partitioned AA, PAA and HP to achieve the same result would be required as the PAA and HP is not partitioned into the pre-established greatest mass of acid.

The order of partitioning, concentrations and ratios of the AA, PAA and HP relative to each other can be organised in respect to their individual functionalities relevant to the perishable food being treated and the considerations necessary for the processing environment that the perishable food is being treated in.

Suitable surface concentrations of peracetic acid range from 0.000001 mg/mm2 to 0.08 mg/mm2, preferably 0.00001 mg/mm2 to 0.015 mg/mm2.

Suitable surface concentrations of Acetic acid in the range of 0.0001 to 0.09 mg/mm2, but preferably 0.001 to 0.029 mg/mm2.

Suitable surface concentrations of hydrogen peroxide range from 0.00001 mg/mm2 to 0.08 mg/mm2, preferably 0.000026 mg/mm2 to 0.015 mg/mm2.

### EXAMPLE 1

The example is calculated at 100% partitioning efficiency.

Partitioned AA vapor only is the simplest configuration of the current invention. This is the only example where treatment was not performed in the pilot plant but performed in a plastic bag without dew point control.

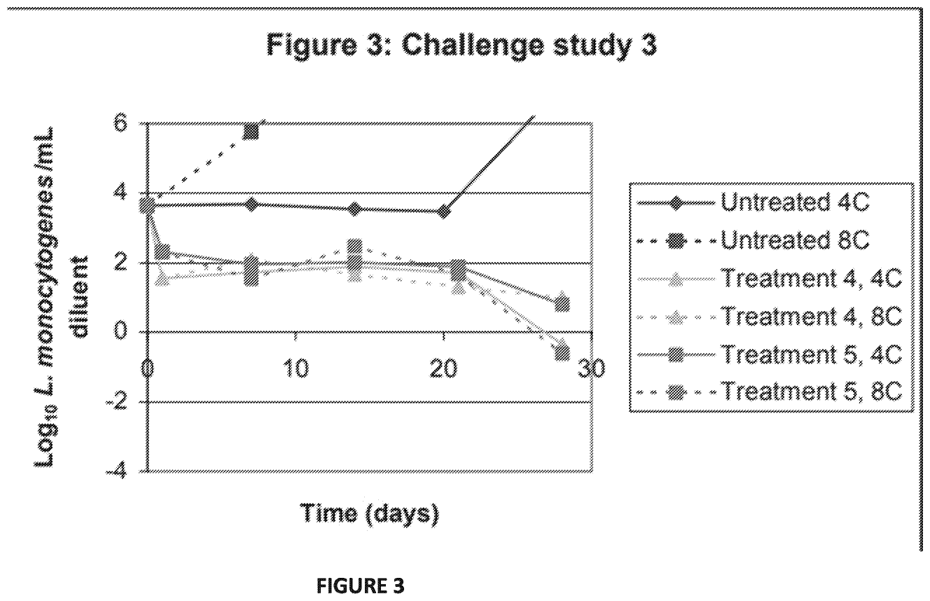

FIG. 3: Challenge study 3, details the log reduction for an AA vapor only Listeria monocytogenes challenge trial. A small diameter cooked sausage product was the substrate and the AA was partitioned to below the flavour threshold at 0.0142 mg/mm2 AA surface concentration.

MAP and vacuum packaging technologies were not required.

Cold chain abuse for the entire 28 days had negligible effect.

L. mono cells could not recover from this simple vapor process.

These results are typical for many perishable foods.

### EXAMPLE 2

Blueberries were vapor phase treated at pilot plant level by the above-described system using a combined PAA and HP vapor process. Residual biocide surface concentration was estimated for the degree of post process contamination, most of which came from the 2500 l/m of unfiltered external air passing over the blueberries as they exited the treatment chamber 14. Other post process contamination was contributed by the punnet surfaces and lids not being closed for up to 5 minutes.

Two preliminary pilot plant trials were required to balance the ratio of partitioned PAA and partitioned HP in order to:
1. Achieve a theoretical surface concentration of PAA in mg/mm2 that would achieve a transient surface concentration by test strip of approximately 1000 mg/l. Most of the PAA had degraded whilst exiting the chamber 14. This data was extrapolated from bench scale plum surface concentrations.
2. Increase the partitioned HP until a residual test strip surface concentration ex the chamber 14 of >100 mg/l was achieved.

The above treatment parameters resulted in the degradation of approximately 90% of the PAA, by test strip, in approximately 29 seconds and maintenance of HP residuals from both biocides sufficient to overcome the substantial post process protection. Having established these process parameters, this process can now be extrapolated to other foods processed in a similar environment or modified for a different processing environment in accordance with GMP and regulatory Maximum Residual Limits.

Visual microbiological shelf life of the treated samples in Table 4 below extended past 94 days in standard punnets sealed in PE bags, however, the visual shelf life was the limiting factor. Standard punnets with holes to permit air circulation, shelf life ended at Day 42 due to berry desiccation, standard punnets in sealed 30-micron PE bags shelf life ended at Day 61 due to slight berry desiccation whilst flavour was typical of Blueberry which could permit berries to be used in manufactured product such as Jams at the end of this visual shelf life. Visible mould was evident in some controls in both pack formats at Day 25. Bloom was not degraded by the treatment but would be degraded by traditional higher water mass wash processes. At 94 days the blueberries were ‘commercially sterile’. However, some berries at 94 days+that were stored at room temperature for a few days exhibited a flavour change.

### Microbiological Analysis:

Mould counts at Day 90 reflected the visual mouldy controls and no visible microbiological growth of the treated samples. All treated samples had no observable microbiological activity during the visual shelf-life assessment which was finalised at Day 120.

TABLE 1
DAY 94 MICROBIOLOGY.

| | | |
|---|---|---|
| Sample Details: Test Description | Results | Units |

001 BLUEBERRY 4.3 C SL 2 - Duplicate 1 (NATA Accredited)

| | | | |
|---|---|---|---|
| FM0011 | Standard Plate Count | 30000 | cfu/g. |
| FM0022 | Yeast | ~42000 | cfu/g. |
| FM0022 | Mould | ~22000 | cfu/g. |

002 BLUEBERRY 4.3 C SL 2 - Duplicate 2 (NATA Accredited)

| | | | |
|---|---|---|---|
| FM0011 | Standard Plate Count | 33000 | cfu/g. |
| FM0022 | Yeast | ~40000 | cfu/g. |
| FM0022 | Mould | ~31000 | cfu/g. |

003 BLUEBERRY 4.3.4 SL 2 - Duplicate 1 (NATA Accredited)

| | | | |
|---|---|---|---|
| FM0011 | Standard Plate Count | <10 | cfu/g. |
| FM0022 | Yeast | <100 | cfu/g. |
| FM0022 | Mould | <100 | cfu/g. |

004 BLUEBERRY 4.3.4 SL 2 - Duplicate 2 (NATA Accredited)

| | | | |
|---|---|---|---|
| FM0011 | Standard Plate Count | <10 | cfu/g. |
| FM0022 | Yeast | <100 | cfu/g. |
| FM0022 | Mould | <100 | cfu/g. |

005 BLUEBERRY 4.3.4. SL 9 - Duplicate 1 (NATA Accredited)

| | | | |
|---|---|---|---|
| FM0011 | Standard Plate Count | <10 | cfu/g. |
| FM0022 | Yeast | <100 | cfu/g. |
| FM0022 | Mould | <100 | cfu/g. |

006 BLUEBERRY 4.3.4. SL 9 - Duplicate 2 (NATA Accredited)

| | | | |
|---|---|---|---|
| FM0011 | Standard Plate Count | <10 | cfu/g. |
| FM0022 | Yeast | <100 | cfu/g. |
| FM0022 | Mould | <100 | cfu/g. |

C = control. All samples stored in standard punnets in sealed PE bags to limit desiccation.

Table 2. below summarises the process specifying the vapor masses transferred and the calculated surface concentrations.

It is possible to achieve a similar result by changing the type of biocides vaporised, vapor concentrations developed, contact time of the vapor to product and therefore the partitioning efficiency. Ratio of partitioned PAA to partitioned HP could also be changed to either increase or decrease the lethality and/or post process protection which would either increase or decrease the process suitability to a specific application.

TABLE 2
Blueberries at 984764 mm2/minute.

| | | | | PAA estimated | |
|---|---|---|---|---|---|
| Mass of PAA | Mass of HP | Surface | Surface | surface | HP estimated |
| vaporised and | vaporised and | concentration of | concentration of | concentration by | surface |
| transferred | transferred | PAA partitioned | HP partitioned | test strip n | concentration by |
| (mg/minute). | (mg/minute). | (mg/mm2). | (mg/mm2). | (mg/l). | test strip (mg/l). |
| 817 | 245 | 0.00083 | 0.00026 | 10 to >160 | Constant >100 |

Greater vapor contact times are used to minimise the mass of biocides transferred to the water scrubber thus reducing the inventions consumable costs and environmental impact. Due to the absence of any negative chemical impact observations the surface concentrations of biocide partitioned could be increased, or AA vapor added if justified by the technological goal.

### EXAMPLE 3

Strawberries that had the last pre-harvest fungicide removed due to several rain events the week prior to harvest were processed through the pilot plant. Controls had visual Botrytis mould growth at day three post-harvest. Treated samples had no visual mould growth at day 13 with a mould count of 100 c.f.u./g. No control mould counts were performed as the berries were overrun with Botrytis mould growth. It was concluded that substantial reductions and control was achieved by the inventive process with a visual shelf of 7 days. The treated berries were visually wet and a greater mass of biocide was partitioned meaning the process naturally adjusted to the higher microbiological load associated with the rain damaged berries. Mechanical damage was identified within 5 minutes post treatment due to the oxidation of the exposed red pigment of the damaged skin to a lighter pink resulting in easier removal of these defects. Berries stored in lower vapor transmission film were visually of better quality.

Table 3 summarises the process.

TABLE 3
Strawberries at 188800 mm2/minute.

| Mass of AA | Mass of HP | Surface | | HP estimated |
|---|---|---|---|---|
| vaporised and | vaporised and | concentration of | Surface | surface |
| transferred | transferred | AA partitioned. | concentration of | concentration by |
| (mg/minute). | (mg/minute). | (mg/mm2). | HP. (mg/mm2). | test strip (mg/l). |
| 1794 | 1007 | 0.0057 | 0.0032 | Constant >100 |

### EXAMPLE 4

trials were conducted on tomatoes to progressively investigate the commercial advantages. Whilst the inventive process achieved a visually microbially stable tomato that when stored at a high humidity and 5 to 18 degrees C. did not exhibit observable mould growth until the skin lost integrity at day 75. The ripening process limited the practical shelf-life extension to approximately 4 days, however up-processing is a viable option. Complimentary treatment with 1-MCP would achieve a general shelf-life extension of 10 to 14 days. Final trial investigated the intentional removal of sections of skin up to approximately 5mm2 to replicate skin damage during harvesting and packing. The removal of skin exposed the inner flesh, having a greater mass of free water than the skin these damage sites attracted at least the same mass of biocide and did not support observable mould growth as reported by the industry partner. Currently major retailers will reject entire pallets if exposed inner flesh is observed as it is deemed that mould will grow whilst on the retail shelf.

Formal microbiological testing was limited to 15 days which is the expected maximum shelf life achievable due to excessive ripening. However, for trial 4 it is reasonable to conclude, based on previous results, that the tomatoes would have remained free from observable mould growth for a substantially longer time than 15 days. Refer Table 4.

TABLE 4
15 Days post treatment.

| | | |
|---|---|---|
| Sample Details: Test Description | Results | Units |

001 CONTROL (NATA Accredited)

| | | | |
|---|---|---|---|
| FM0011 | Standard Plate Count | 7200 | cfu/g. |
| FM0022 | Yeast | 100 | cfu/g. |
| FM0022 | Mould | 5000 | cfu/g. |

002 T1 (NATA Accredited)

| | | | |
|---|---|---|---|
| FM0011 | Standard Plate Count | 21000 | cfu/g. |
| FM0022 | Yeast | <100 | cfu/g. |
| FM0022 | Mould | 7000 | cfu/g. |

003 T2 (NATA Accredited)

| | | | |
|---|---|---|---|
| FM0011 | Standard Plate Count | ~20 | cfu/g. |
| FM0022 | Yeast | <100 | cfu/g. |
| FM0022 | Mould | 100 | cfu/g. |

004 T3 (NATA Accredited)

| | | | |
|---|---|---|---|
| FM0011 | Standard Plate Count | ~10 | cfu/g. |
| FM0022 | Yeast | <100 | cfu/g. |
| FM0022 | Mould | 100 | cfu/g. |

005 T4 (NATA Accredited)

| | | | |
|---|---|---|---|
| FM0011 | Standard Plate Count | ~10 | cfu/g. |
| FM0022 | Yeast | <100 | cfu/g. |
| FM0022 | Mould | <100 | cfu/g. |

Table 5. summarises the process.

TABLE 5
Tomatoes at 273598 mm2/minute.

| Mass of AA | Mass of HP | Surface | Surface | HP estimated |
|---|---|---|---|---|
| vaporised and | vaporised and | concentration of | concentration of | surface |
| transferred | transferred | AA partitioned. | HP partitioned. | concentration by |
| (mg/minute). | (mg/minute). | (mg/mm2). | (mg/mm2). | test strip (mg/l). |
| 2923 | 100 | 0.0064 | 0.00022 | 10 to 100 |

### EXAMPLE 5

### Calculated at 70% Partitioning Efficiency

### Comparison of Effectiveness of Individual and Combined Gaseous Biocides With and Without Fungicide Applied To Mandarins

Following Table 5 tabulates the initial 9 trials investigated to eliminate the use of the traditional expense, less effective and quality degrading fungicide. This mandarin example is typical of initial trials required to determine:
1. Effect of individual biocides on the food being investigated:
   a. Too greater HP surface concentration resulted in a ‘burnt orange’ skin.
   b. Too greater AA surface concentration resulted in a ‘brown’ skin colouration.
2. Optimisation of concentrations and ratio of the biocides to achieve maximum lethal concentrations and minimal undesirable chemical impacts.

All combined fungicide and gaseous treatments were effective* with mould counts typically <10 c.f.u./g with better quality skin than fungicide only.

For mandarins without fungicide T5 was the best combined treatment requiring 22% less AA than the minimum effective AA only treatment (T8) and 70% less HP than the minimum (T2). Microbial counts indicated that AA on the mandarin effective HP only treatment substrate is possibly the most lethal, therefore PAA may be the more effective oxidant.

These trial results were achieved with excessive biocide partitioning to the flat tops and bottoms of the mandarin. Angle of vapor impingement was changed from 90 degrees to 45 degrees, top manifold facing leading edge and bottom manifolding facing trailing edge and spacing at least 60% the diameter of the mandarin along length of belt achieved uniform vapor application which will further increase process lethality. Transverse spacing was not as critical.

*Treatment deemed effective if no observable mould growth at 6 weeks.

TABLE 5
Lower limit of detection was decreased by
a factor of 10 to differentiate treatments.

| | |
|---|---|
| TRIAL DESCRIPTION | MICROBIAL COUNTS |

NO GASEOUS BICIDE TREATMENT

| 0617 CONTROL FUNGICIDE | Standard Plate Count | 540 |
|---|---|---|
| | Yeast | 100 |
| | Mould | 100 |
| 0617 CONTROL NO FUNGICIDE | Standard Plate Count | 18 |
| | Yeast | 880 |
| | Mould | 1400 |
| SURFACE CONCENTRATION mg/mm2 | | H2O2 = 0.0001 |
| 0617 T1 FUNGICIDE | Standard Plate Count | 11 |
| | Yeast | 110 |
| | Mould | 20 |
| 0617 T1 NO FUNGICIDE | Standard Plate Count | 1300 |
| | Yeast | 1600 |
| | Mould | 290 |
| SURFACE CONCENTRATION mg/mm2 | | H2O2 = 0.0003 |
| 0617 T2 FUNGICIDE | Standard Plate Count | 50 |
| | Yeast | <10 |
| | Mould | 30 |
| 0617 T2 NO FUNGICIDE | Standard Plate Count | 650 |
| | Yeast | 830 |
| | Mould | 80 |
| | 0.003 | |
| SURFACE CONCENTRATION mg/mm2 | Acetic acid = 0.003 | |
| 0617 T7 FUNGICIDE | Standard Plate Count | 10 |
| | Yeast | <10 |
| | Mould | 60 |
| 0617 T7 NO FUNGICIDE | Standard Plate Count | 2 |
| | Yeast | 210 |
| | Mould | 100 |
| SURFACE CONCENTRATION mg/mm2 | Acetic acid = 0.0043 | |
| 0617 T8 FUNGICIDE | Standard Plate Count | 9 |
| | Yeast | <10 |
| | Mould | <10 |
| 0617 T8 NO FUNGICIDE | Standard Plate Count | 45 |
| | Yeast | <10 |
| | Mould | 80 |
| TRIAL DESCRIPTION | MICROBIAL COUNTS | |
| SURFACE CONCENTRATION mg/mm2 | Acetic acid = 0.00641 | |
| 0617 T6 FUNGICIDE | Standard Plate Count | 20 |
| | Yeast | <10 |
| | Mould | <10 |
| 0617 T6 NO FUNGICIDE | Standard Plate Count | 27 |
| | Yeast | 20 |
| | Mould | 40 |
| SURFACE CONCENTRATION mg/mm2 | Acetic acid = 0.010 | |
| 0617 T9 FUNGICIDE | Standard Plate Count | 20 |
| | Yeast | <10 |
| | Mould | <10 |
| 0617 T9 NO FUNGICIDE | Standard Plate Count | 420 |
| | Yeast | 10 |
| | Mould | 80 |
| SURFACE CONCENTRATION mg/mm2 | Acetic acid = 0.00013 | H2O2 = 0.00044 |
| 0617 T3 FUNGICIDE | Standard Plate Count | 17 |
| | Yeast | <10 |
| | Mould | <10 |
| 0617 T3 NO FUNGICIDE | Standard Plate Count | 190 |
| | Yeast | 420 |
| | Mould | 1900 |
| SURFACE CONCENTRATION mg/mm2 | Acetic acid = 0.00029 | H2O2 = 0.000867 |
| 0617 T4 FUNGICIDE | Standard Plate Count | 29 |
| | Yeast | <10 |
| | Mould | 20 |
| 0617 T4 NO FUNGICIDE | Standard Plate Count | 35 |
| | Yeast | 90 |
| | Mould | 30 |
| SURFACE CONCENTRATION mg/mm2 | Acetic acid = 0.00335 | H2O2 = 0.00009 |
| 0617 T5 FUNGICIDE | Standard Plate Count | 21 |
| | Yeast | <10 |
| | Mould | <10 |
| 0617 T5 NO FUNGICIDE | Standard Plate Count | 2 |
| | Yeast | <10 |
| | Mould | 40 |

Table 6 is an example of the process sheet with the major variables.

Many modifications of the above embodiments will be apparent to those skilled in the art without departing from the scope of the present invention. In particular, a wide range of surface biocide/s partitioned concentrations is specified in this specification in recognition of the wide range of process variables that can be altered to achieve similar results across a wide range of food types with complex reactions with these previously unachievable biocide mixtures and high surface concentrations, furthermore a new complexed and accurate method to apply these gaseous biocides controlled by the surface concentrations in mg/mm2 as calculated using the variables specified.

Throughout this specification and the claims which follow, unless the context requires otherwise, the word “comprise”, and variations such as “comprises” and “comprising”, will be understood to imply the inclusion of a stated integer or step or group of integers or steps but not the exclusion of any other integer or step or group of integers or steps. Also, the reference to a single chemical composition in a biocide does not exclude the presence of other compositions therein, particularly biocides.

The words vapor and gas mean a true gas.

The reference in this specification to any prior publication (or information derived from it), or to any matter which is known, is not, and should not be taken as an acknowledgment or admission or any form of suggestion that that prior publication (or information derived from it) or known matter forms part of the common general knowledge in the field of endeavour to which this specification relates.

1-31. (canceled)

32. A system for applying a gaseous biocide to a foodstuff, comprising:
a supply of gaseous biocide for supplying the gaseous biocide above a dew point of the biocide;
a treatment chamber having a vapor partitioning passage disposed therein and in which the gaseous biocide is applied to the foodstuff;
a conveyor for conveying the foodstuff, the conveyor extending from a first location outside of the treatment chamber, through a first aperture in a wall of the treatment chamber, through the vapor partitioning passage, through a second aperture in a wall of the treatment chamber, and terminating at a second location outside the treatment chamber;
an air distribution system configured to supply air into the treatment chamber, and
an air extraction system through which air from the air distribution system, external air and remaining biocide is drawn from the treatment chamber;
wherein the first and second apertures are sized to allow the foodstuff and air from outside of the treatment chamber to pass therethrough and ends of the vapor partitioning passage are spaced from the first and second apertures, and
wherein air pressure within the treatment chamber is maintained lower than that outside the treatment chamber and lower than that within the vapor partitioning passage, whereby air drawn into the treatment chamber from outside thereof is directed away from the vapor partitioning passage and gaseous biocide is prevented from exiting the treatment chamber and
wherein the air distribution system further comprises a heated air supply for heating gas surrounding the conveyor belt to maintain the temperature of the conveyor belt above dew point of the biocide.

33. A system according to claim 32, wherein an air pressure just outside of ends of the vapor partitioning passage is lower than that within the vapor partitioning passage to reduce air drawn into the vapor partitioning passage.

34. A system according to claim 32, wherein the air distribution system is configured to maintain the temperature of surfaces in the treatment chamber above a dew point of the gaseous biocide.

35. A system according to claim 32, wherein the temperature of the gaseous biocide entering the vapour partitioning passage is sufficiently high so as to heat internal surfaces of the vapour partitioning passage to a temperature above dew point of the biocide.

36. A system according to claim 32, wherein the conveyor has upper and lower sections, the upper section passing through the vapor partitioning passage and the lower section passing through a stream of heated air from the heater of the air distribution system, whereby a temperature of the conveyor is maintained above a dew point of the biocide to prevent condensation of the biocide and vaporise partitioned or condensed biocide incident thereon.

37. A system according to claim 32, wherein the air distribution system comprises a conduit positioned underneath the vapour partitioning passage.

38. A system according to claim 37, wherein the treatment chamber comprises a heater for heating the air within the conduit.

39. A system according to claim 38, comprising a plurality of diffusers operably connected to the conduit for supplying heated air towards the conveyor belt and vapour partitioning passage.

40. A system according to claim 32, comprising three or more biocide vessels, each containing one of hydrogen peroxide, acetic acid or peracetic acid and a separate water vessel, the system being configured to individually vaporise the three or more biocides, with or without vaporising water.

41. A system according to claim 32, further comprising a vaporisation chamber separate from the treatment chamber and in which vaporisation of the biocide occurs, the vaporisation chamber having:
a plurality of pumps through which liquid biocides are metered; and
a vaporiser in communication with the pumps for generating the gaseous biocide, the gaseous biocide being conveyed within a gaseous biocide conduit.

42. A system according to claim 41, wherein the system comprises a gaseous biocide conduit extending from the vaporisation chamber to the vapour partitioning passage of the treatment chamber.

43. A system according to claim 42, further comprising an enclosing conduit enclosing the gaseous biocide conduit, the enclosing conduit including air at a negative pressure to that of the vapour inside the gaseous biocide conduit.

44. A system according to claim 43, wherein the gaseous biocide exits the vaporiser at around 120 to 250 degrees Celsius and the air in the enclosing conduit acts to reduce the temperature of the gaseous biocide to a temperature above the dew point of the gaseous biocide before supplying it to the vapour partitioning passage.

45. A system according to claim 41, further including a monitoring system for monitoring the amount of the biocide being applied to the foodstuff, the monitoring system being configured to determine the amount of biocide (and water where used) vaporised and transferred per unit time in mg/minute and, for inputted parameters relating to % partitioning efficiency, foodstuff production rate in mg mm2/minute, liquid biocide concentration and, outputting a calculated partitioned biocide surface concentration in mg/mm2.

46. A system according to claim 45, wherein the calculated surface concentration is compared to the process surface concentration set point and the system controls the process variables to stay within the specified range of the foodstuff's set point surface concentration in mg/mm2.

47. A system according to claim 41, wherein the vaporiser comprises at least one gaseous biocide supply tube within which vapourisation occurs, the at least one biocide supply tube comprising PFA.

48. A system according to claim 32, wherein the surfaces to which the gaseous biocide is applied include the wetted and/or cooled surfaces of the foodstuff, including at an interface between the conveyor belt and foodstuff.

49. A system according to claim 32, wherein the system further comprises at least one other vapour partitioning passage configured for applying biocide to equipment adapted to be in contact with the foodstuff, in use.

50. A method for reducing the microbial content on the surface of a foodstuff which is susceptible to microbial spoilage, the method comprising the steps of:
providing a system according to claim 32,
applying the gaseous biocide to the foodstuff.

51. A method according to claim 50, further comprising the step of increasing a mass of surface water on the foodstuff prior to or whilst applying the biocide.

52. A method according to claim 50, wherein the biocide is an acid and a pH of the biocide vapor partitioned on the surface of the foodstuff is in the range of 0.8 to 4.50.

53. A method according to claim 50, wherein the biocide partitioned on the surface of the foodstuff is peracetic acid at a surface mass in the range of 0.000001 mg/mm2 to 0.08 mg/mm2.

54. A method according to claim 50, wherein the biocide partitioned on the surface of the foodstuff is hydrogen peroxide at a surface mass in the range of 0.00001 mg/mm2 to 0.08 mg/mm2.

55. A method according to claim 50, wherein the gaseous biocide is comprised of two or more individual biocides, applied to the foodstuff simultaneously, in overlapping or separate steps.
